(19) United States
(12) Patent Application Publication
(10) Pub. No.: US 2011/0037411 A1
(43) Pub. Date: Feb. 17, 2011

(54) MOULDING WITH EMBEDDED LIGHTING

(76) Inventor: Norik BONYADI, Richmond Hill (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(21) Appl. No.: 12/634,230

(22) Filed: Dec. 9, 2009

(30) Foreign Application Priority Data
Aug. 13, 2009 (CA) 2675390

(51) Int. Cl. H05B 37/02; F21S 8/00; H01J 9/24

(52) U.S. Cl. 315/294; 362/147; 445/23

(57) ABSTRACT

A decorative moulding having embedded lighting that is directly visible through a hole in the moulding when viewed from a front surface of the moulding, and a method of making a modular moulding having embedded lighting. The lighting is provided by a light source, preferably a light emitting diode, that is positioned in a light mount. The light mount is fixed to the substrate with the light source in the hole in the moulding. A plurality of light mounts can be positioned in a respective plurality of holes in the substrate at desired spacings with light mounts connected to each adjacent light mount by electrically conductive wires. The decorative moulding can be manufactured as modular pieces and the electrically conductive wires can be connected to wires of adjacent modular pieces.

### CROSS REFERENCE TO RELATED APPLICATIONS

This application claims the benefit of priority of Canadian Patent Application No. 2,675,390, filed Aug. 13, 2009, which is incorporated herein by reference in its entirety.

### FIELD OF THE INVENTION

This invention relates to mouldings having embedded lighting, the mouldings being used in construction to cover transitions between surfaces or for decoration.

### BACKGROUND OF THE INVENTION

It is known to provide indirect lighting behind decorative moulding. In typical installations, crown moulding is fixed to a wall at a distance spaced vertically downward from a ceiling. Lighting is connected to a power source and positioned behind the crown moulding so that it is between the crown moulding and the wall. Typically, a rope light consisting of strings of small incandescent light bulbs within tubes of flexible material is used as the lighting. When the rope light is turned on, the bulbs shine light up the wall towards the ceiling to provide indirect lighting.

Because known lighting used with mouldings is indirect and shines upwards from behind the moulding, a space must be provided above the moulding to allow the light to shine. As such, the decorative moulding can not be fixed directly over the joint between the wall and the ceiling. Also, the decorative moulding used in known methods of providing lighting must have large space to permit lights to be positioned behind the moulding. Using rope lights is disadvantageous as the spacing between bulbs is fixed when the rope lights are manufactured. As such, a user can not alter spacings between bulbs to achieve preferred spacings. Also, bulbs closest to an end of rope lighting connected to a power source are brighter than bulbs at the opposite end, and uneven lighting results along the length of rope lighting.

Therefore, a need exists for providing direct lighting with decorative mouldings used in construction that overcomes these disadvantages.

### SUMMARY OF THE INVENTION

The present invention is directed to decorative moulding with embedded lighting that is directly visible from a front surface of the moulding. The invention generally consists of modular pieces of moulding, for example crown moulding. The moulding is provided with one or more holes from a front surface to a back surface of the moulding. A light mount is fixed to the back surface of the moulding. A light source is inserted into the light mount so that the light source is within the hole. When the light source is illuminated, light is directly visible when the moulding is viewed from the front surface.

The decorative moulding of the present invention is advantageous as a user can alter a distance between bulbs to achieve preferred spacings. Preferably, Light Emitting Diodes (“LED's”) are used as the light source. LED's do not suffer the disadvantage of uneven lighting as occurs with rope lights. Therefore, LED's provide consistent brightness of each light source.

In one aspect, the present invention resides in a moulding having embedded lighting, the moulding comprising a substrate having a front surface and a rear surface, a hole through the front surface to the rear surface, a light mount positioned on the substrate with a light source connected in the light mount and the light source is positioned in the hole so that light is visible from the front surface through the hole to provide direct lighting when the moulding is viewed from the front surface.

In another aspect, the present invention resides in a method of making a modular moulding having embedded lighting, the method comprising the steps of: obtaining a moulding having a front surface and a rear surface; making a one hole in the moulding from the front surface to the rear surface; fixing a light mount on the rear surface, the light mount having a light source positioned in the hole such that light from the light source can be seen from the front surface through the hole to provide direct lighting.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows a decorative moulding having embedded lighting in accordance with one embodiment of the present invention, as shown in perspective view;

FIG. 2 shows the decorative moulding of FIG. 1 in plan view as viewed from a front surface wherein the decorative moulding is a modular unit;

FIG. 3 shows a perspective view the decorative moulding of FIG. 2 from a back surface;

FIG. 4 shows a cross-sectional view of the decorative moulding of FIG. 1 as mounted at the joint between a ceiling and a wall of a room;

FIG. 5 shows a cross-sectional view of the decorative moulding of FIG. 1 as mounted at the joint between a ceiling and a wall of a room, the light mount and light source being in accordance with another embodiment of the present invention;

FIG. 6 shows a cross-sectional view of the decorative moulding of FIG. 5 with the light mount oriented in a accordance with a different embodiment of the present invention;

FIG. 7 shows a cross-sectional view of the decorative moulding of FIG. 1 as mounted at the joint between a ceiling and a wall of a room, wherein the light mount and light source are in accordance with another embodiment of the present invention;

FIG. 8 shows a perspective view of the decorative moulding of the present invention installed at the joint of a ceiling and a wall of a room;

FIG. 9 shows a decorative moulding of the present invention installed along walls of a room and spaced vertically downwardly from the ceiling;

FIG. 10 shows a decorative moulding in accordance with another embodiment of the present invention wherein the decorative moulding is baseboard having embedded lights therein;

FIG. 11 shows a perspective view of the decorative moulding of FIG. 10 from a back surface;

FIG. 12 shows the light mount and LED and driver board of FIG. 5 in exploded view;

FIG. 13 shows a decorative moulding in accordance with another embodiment of the present invention wherein the decorative moulding is a centrepiece moulding having embedded lights therein; and

FIG. 14 shows a perspective view of the decorative moulding shown in FIG. 13.

### DETAILED DESCRIPTION OF THE PREFERRED EMBODIMENT

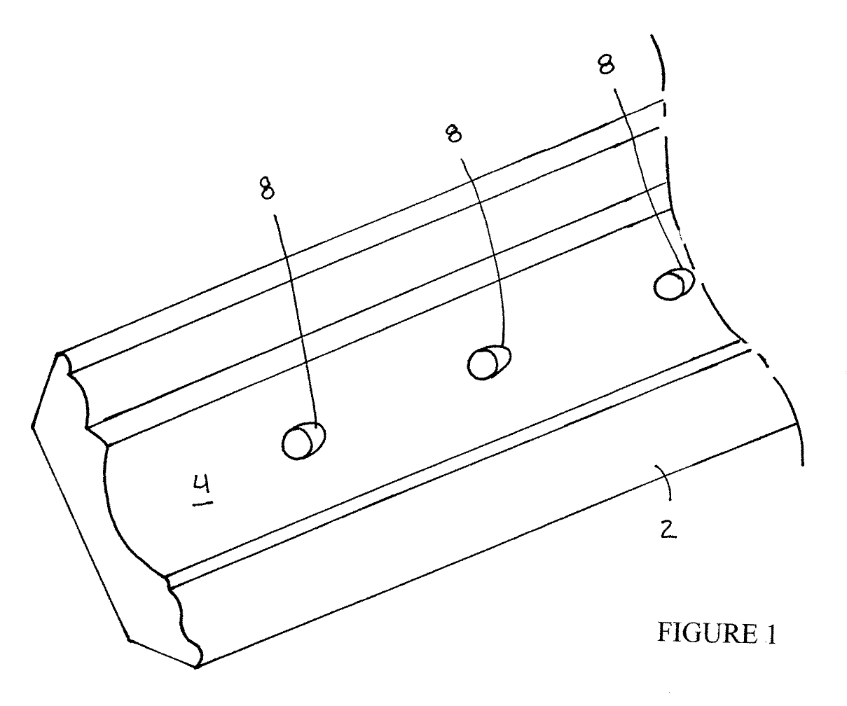

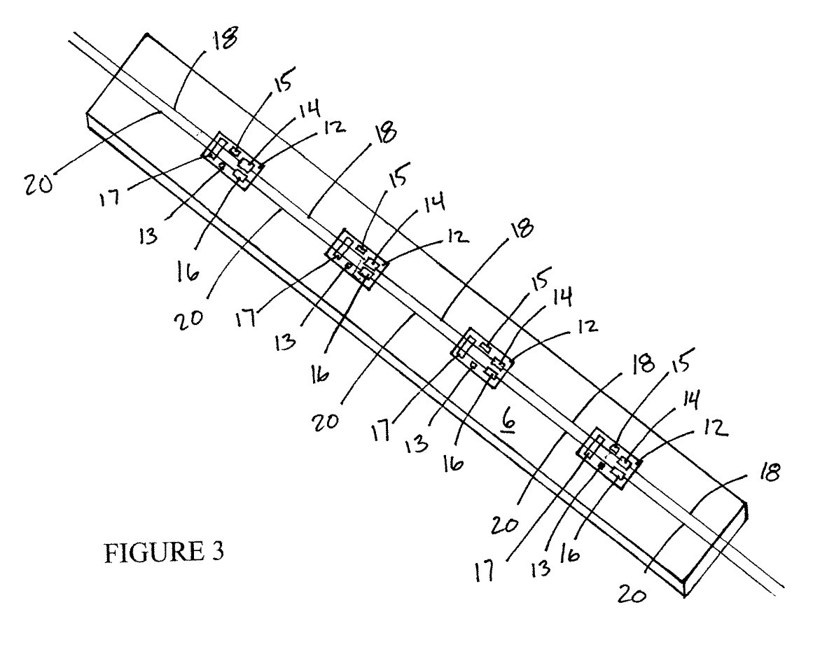

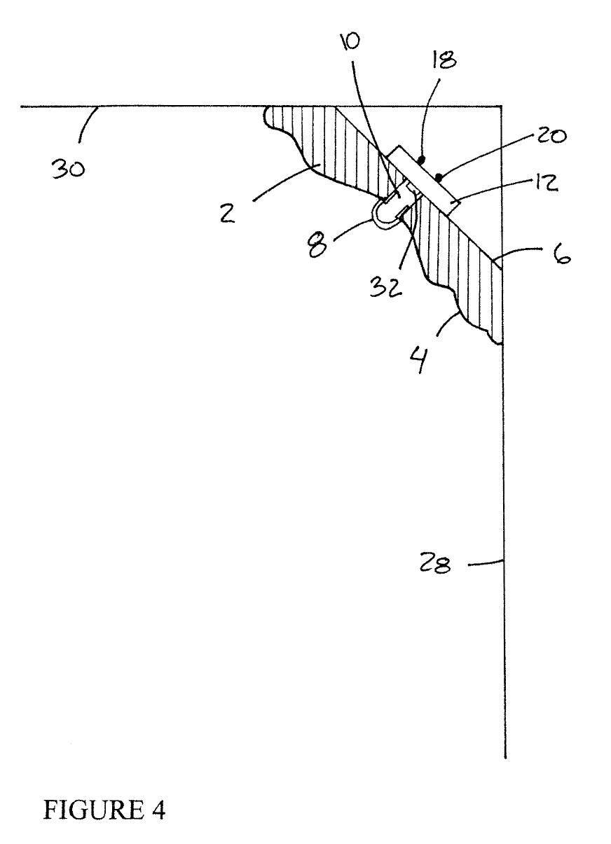

FIG. 1 shows the decorative moulding 2 having a front surface 4 and a back surface 6, shown in FIG. 3. The decorative moulding 2 can be made of wood, foam or plaster. Light cover lenses 8 are fitted into holes through the front surface 4. The light cover lenses 8 are fitted into the holes 10 by friction fit and are easily removed for painting and cleaning. When a light source, such as an LED shown in FIG. 4, is illuminated, the light shines through the light cover lenses 8 to provide direct lighting when the moulding is viewed from the front surface 4.

In preferred embodiments, the light cover lenses 8 can be different colours, including alternating patterns of colours, for example, to suit an occasion such as a Christmas or birthday party. Alternatively, the light source or LED can be different colours and alternating patterns of colours can be achieved by providing different colours of LED's in a pattern along the moulding 2.

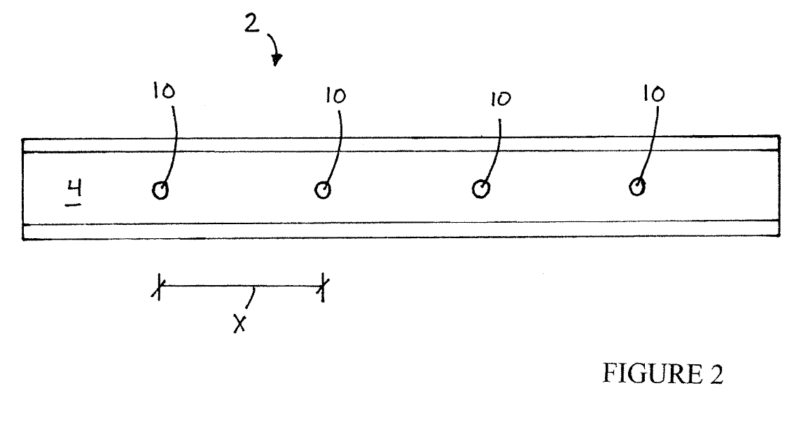

FIG. 2 shows the decorative moulding 2 in plan view from the front surface 4. The decorative moulding 2 is formed as a modular unit. As shown, the light cover lenses 8 are spaced from each other at a distance X. The distance between light cover lenses 8 can be established by a manufacturer making the decorative moulding 2. As such, different mouldings with different spacing can be manufactured and sold to suit a user's need. In a preferred embodiment, a user could buy a kit containing the lighting assembly and moulding separately, and the user could drill holes in the moulding at a desired spacing.

The decorative moulding 2 shown in FIG. 2 can be cut to a desired length and, if required, to meet with a consecutive piece of decorative moulding 2.

FIG. 3 shows the moulding 2 viewed from a back surface 6. Light mounts 12 are fixed to the back surface 6 over top of the holes 10 shown in FIG. 2. The light mounts can be fixed either by glue or mechanical fasteners such as a screw.

Each light mount 12 has a positive electrical contact 14 and a negative electrical contact 16. The electrical light mounts 12 are connected in parallel by positive electricity carrying wire 18 and negative electricity carrying wire 20 connected to the respective contacts 14 and 16, preferably by soldering. By connecting the LED light mounts in parallel, if one light fails, the other light will not be affected.

Each light mount 12 has a current reference 13 and a current controller 15. The current reference 13 and the current controller 15 co-operate to set the current intensity delivered to the LED to thereby set the intensity of light of the LED. Each light mount 12 also has an LED housing 17 which electrically connects the LED to the current reference 13 and current controller 15.

FIG. 4 shows the decorative moulding of FIG. 1 mounted at the joint between a wall 28 and a ceiling 30 of a room. As shown, the decorative moulding 2 has a hole 32 with an LED 34 positioned therein. The LED lights can be low voltage of 12 volts and can last up to 50,000 hours of use. The light intensity of the LED lights can be preset.

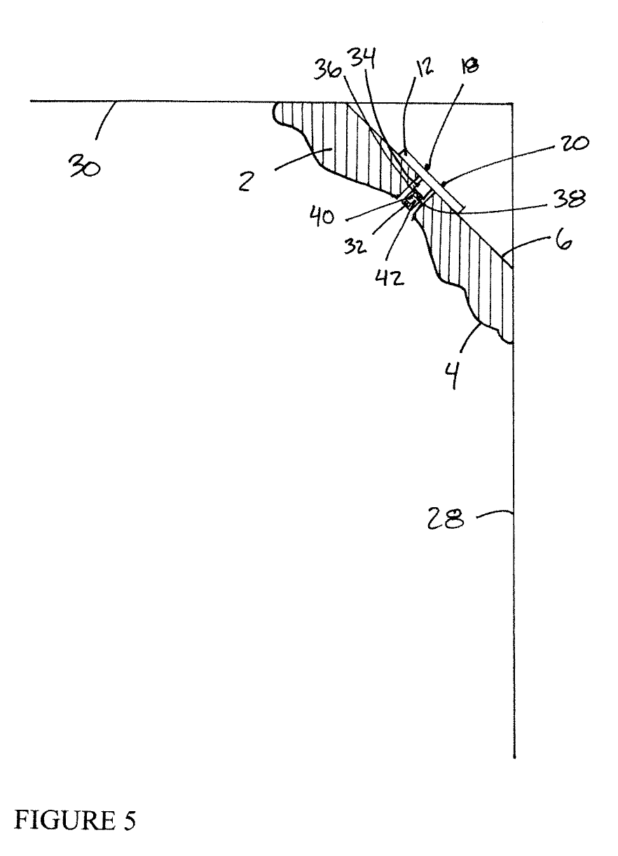

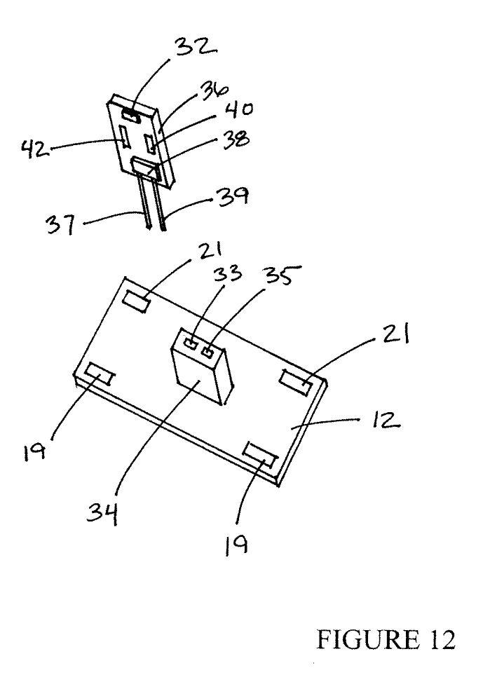

FIG. 5 shows the decorative moulding of FIG. 1 mounted at the joint between the wall 20 and the ceiling 30 of a room. In the embodiment shown, the electrical light mount plate 12 is fixed to the back of the surface 6. The electricity carrying wires 18 and 20 are soldered to respective electrical contacts 14 and 21, shown in FIG. 12 on the electrical light mount 12.

In the embodiment shown in FIG. 5, a light mount socket 34 is fixed to the light mount plate 12 and positioned within the hole 10. The light mount socket 34 has a first aperture 33 and a second aperture 35, shown in FIG. 12. LED and driver board 36 has a first tine 37 and a second tine 39 which are insertable into the first aperture 33 and the second aperture 35.

The LED and driver board 36 is removably insertable into the socket 34 so that different LED's as for example, having a different colour or light intensity, can be interchanged.

The LED and driver board 36 has a diode bridge or rectifier 38 connected to the first and second tines 37 and 39 as shown in FIG. 12. The diode bridge 38 advantageously provides that the LED and driver board 36 can be inserted into the socket 34 without regard for which of the first tine 37 or second tine 39 is inserted into the first aperture 33 or the second aperture 35. For example, the diode bridge 38 provides that a flow of current to the LED is always from the first tine 37 to the second tine 39 regardless of whether the first tine 37 is inserted into the first aperture 33 or the second aperture 35.

The LED and driver board 36 also has a current reference 40 and a current controller 42. The current reference 40 and current controller 42 operate to control an amount of current delivered to the LED 32 to control the light intensity of the LED 32. The current reference 40 and current controller 42 can be set on manufacture for a specific intensity as preferred by a user. Also, the LED and driver board 36 is removably insertable so that different LED's, for example, having different intensity or colour, can be removably inserted.

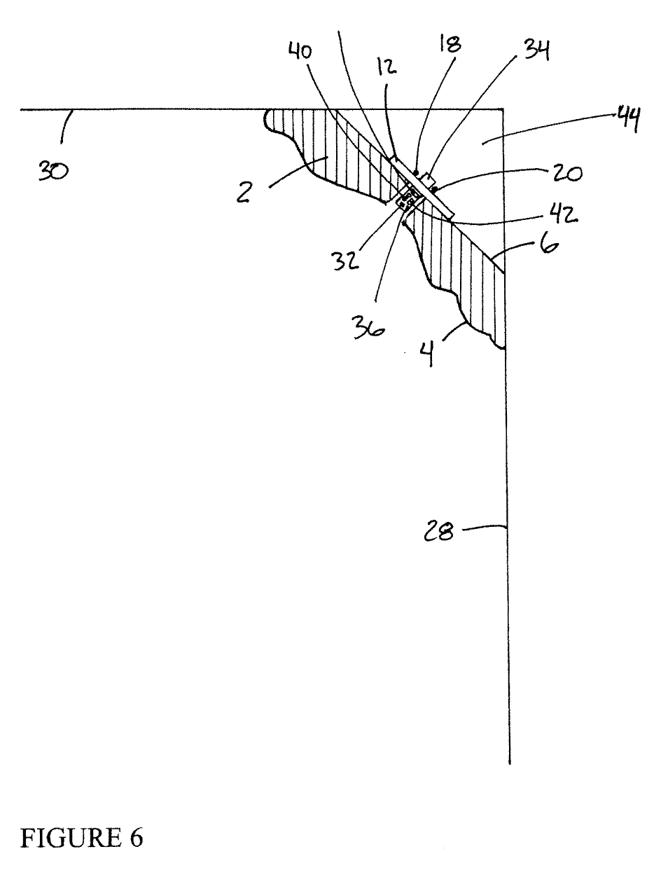

FIG. 6 shows a similar cross-sectional view of the decorative moulding mounted at the joint between the wall 28 and the ceiling 30 of a room as shown in FIG. 5. FIG. 6 differs from the embodiment shown in FIG. 5 in that the electrical light mount 12 is fixed to the rear surface 6 with the socket 34 positioned away from the hole 10. This can be done to suit an application for example where a thickness of the moulding 2 is smaller and it is desired that the LED 32 not extend past the front surface 4 of the moulding 2. By positioning the socket 34 in the pocket 44 between the wall 28 and the ceiling 30, the LED 32 is positioned closer to the light mount plate 12.

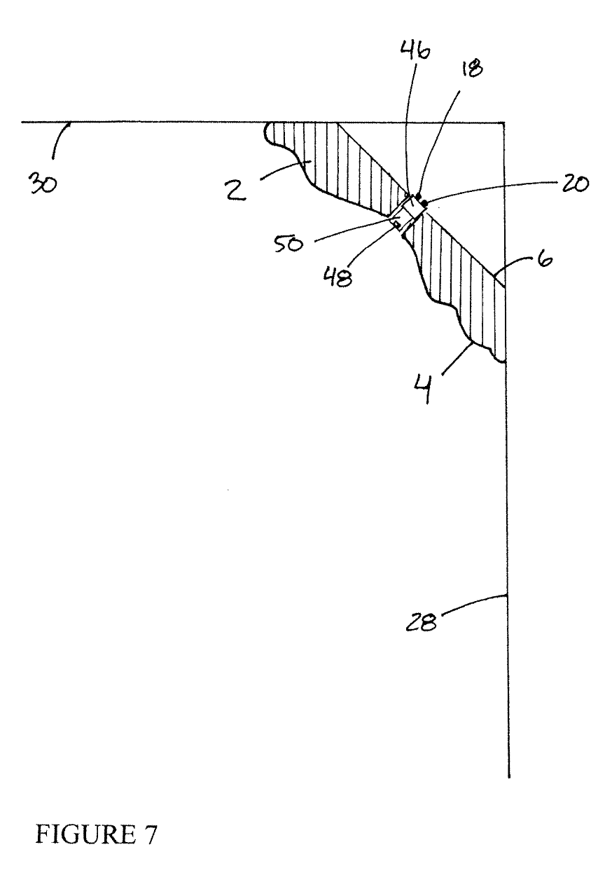

FIG. 7 shows the decorative moulding of FIG. 1 mounted at the joint between the wall 28 and the ceiling 30 with a light mount socket 46 inserted in the hole 10 in accordance with another embodiment. The light mount socket 46 is preferably fixed by friction fit into the hole 10. The electrically connecting wires 18 and 20 are fixed to the light mount socket 46 to provide electricity thereto. An LED 48 is mounted to a bulb mount 50 and connected to the light mount socket 46. As shown, the LED 48 is positioned proximate to the front surface 4 of the substrate 2. This provides for increased viewing angle of the light placed by the LED 48.

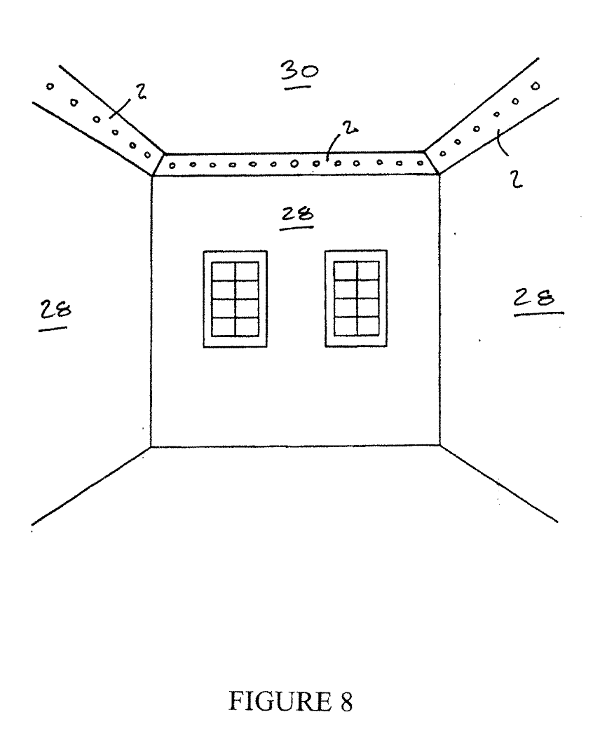

FIG. 8 shows a perspective view of the decorative moulding 2 of the present invention installed at the joint of a ceiling and wall of a room. This decorative moulding could also be installed as crown moulding above kitchen cabinets. Although not shown, it is understood that the electrical wire carrying electricity from a source to the decorative moulding 2 would pass through the wall 20 or the ceiling 30 to the strip substrate 2 in the pocket 44 shown in FIG. 6. This way, the electrical wire is not seen.

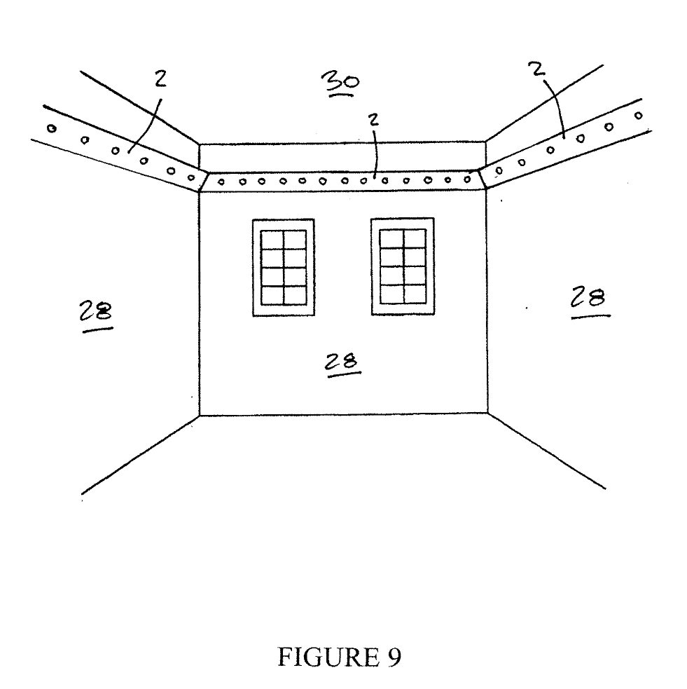

FIG. 9 shows a decorative moulding 2 of the present invention installed along walls of a room and spaced vertically downwardly from the ceiling.

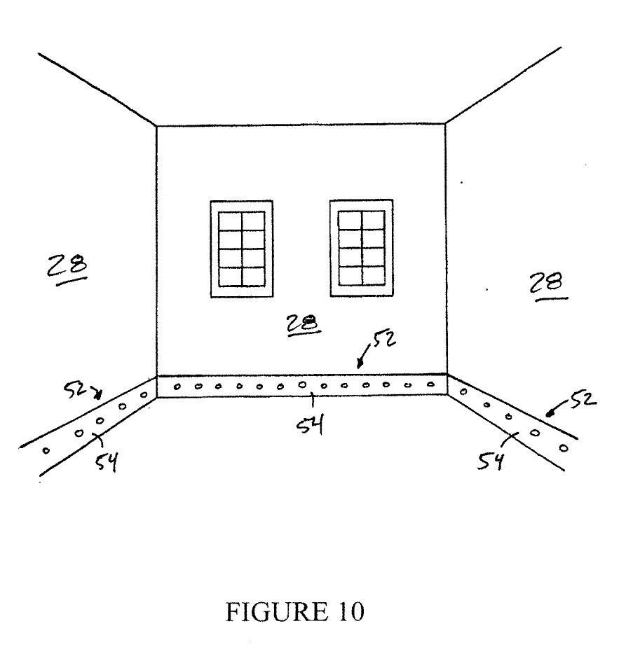

FIG. 10 shows a decorative moulding 2 in accordance with another embodiment of the present invention wherein the decorative moulding 2 is baseboard having embedded lights therein. The embedded lights are visible from a first surface.

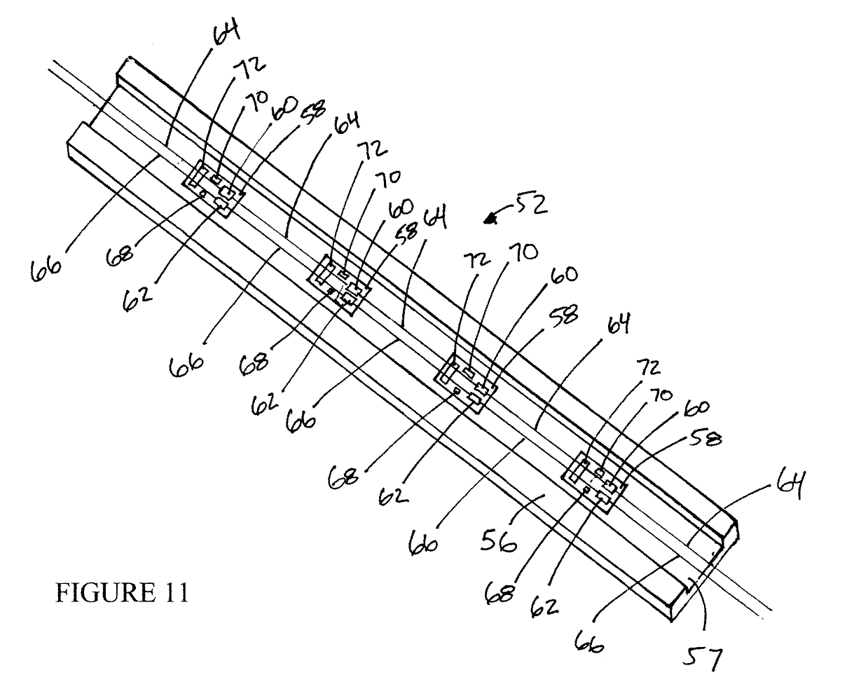

FIG. 11 shows a perspective view of the decorative moulding 2 as shown in FIG. 10 from a back surface 56. As shown, a cut away portion 57 is provided so that the light mounts 58 are inwardly recessed from the back surface 56 to enable flush mounting of the baseboard 52 to a wall.

Each of the light mounts 58 has a positive electrical contact 60 and a negative electrical contact 62. A positive electrical carrying wire 64 is connected to each of the positive electrical contact 60 for example by welding a negative electric carrying wire 66 is connected to each of the negative electrical contact 62 for example by welding.

Each of the light mounts 58 has a current reference 68 and current controller 70. The current reference 68 and the current controller 70 cooperate to set a current intensity that is delivered to the LED (not shown). The light mounts 58 also have a LED housing 72 electrically connecting the LED (not shown) to the current reference 68 and current controller 70.

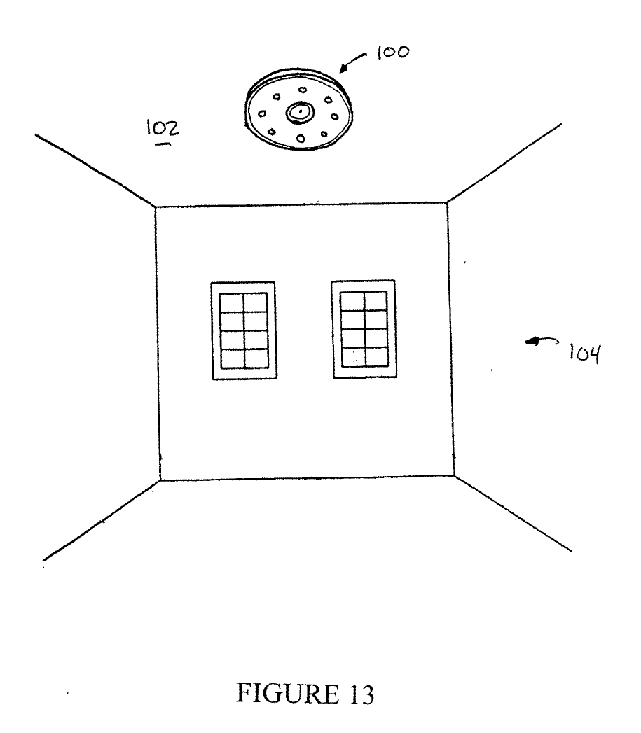

FIG. 13 shows a centrepiece decorative moulding or medallion 100 in accordance with another embodiment of the present invention. The centrepiece moulding 100 is shown in FIG. 13 mounted to a ceiling 102 of a room 104.

The centrepiece moulding 100 is circular in shape. The centrepiece moulding 100 is not limited to the circular shape shown and for example could be oval, square, or rectangular. The centrepiece moulding 100 can be made of wood, foam or plaster.

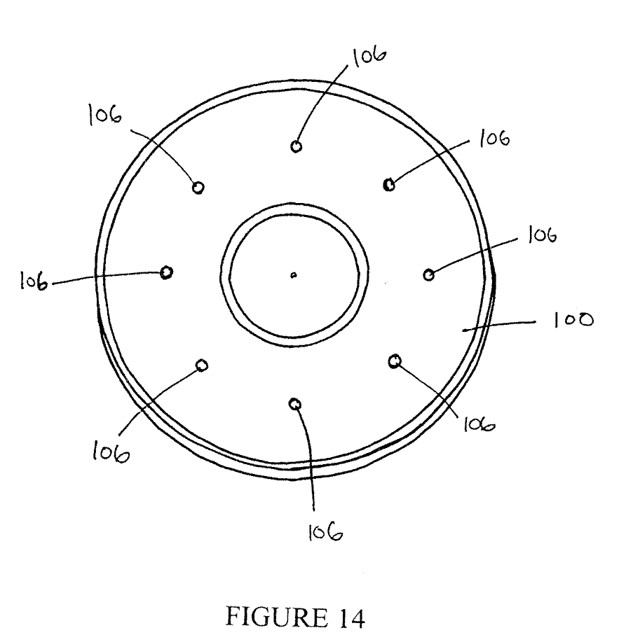

The centrepiece moulding 100 has holes 106 which have lights embedded therein. The centrepiece moulding 100 is shown in more detail in the perspective view in FIG. 14. The lights 106 are embedded in the holes in accordance with any of the embodiments previously described with reference to FIGS. 1 to 12.

A cut away portion or recess such as the cut away portion 57 shown in FIG. 11 may be required so that the centrepiece moulding 100 can be mounted flush to the ceiling. The cut away portion would allow light mounts to be recessed from a back surface of the centrepiece moulding 100 to enable flush mounting to the ceiling 102 in the same manner that the baseboard is mounted flush to the wall in FIG. 10.

It is to be appreciated that the light source and LED's at the embodiments hereinbefore described are dimmable, for example, using a dimming switch in place of an on/off switch for the electrical circuit providing power to the lights.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein.

It will be understood that, although various features of the invention have been described with respect to one or another of the embodiments of the invention, the various features and embodiments of the invention may be combined or used in conjunction with other features and embodiments of the invention as described and illustrated herein.

1. A moulding having embedded lighting, the moulding comprising a substrate having a front surface and a rear surface, a hole through the front surface to the rear surface, a light mount positioned on the substrate with a light source connected in the light mount and the light source is positioned in the hole so that light is visible from the front surface through the hole to provide direct lighting when the moulding is viewed from the front surface.

2. The moulding of claim 1, wherein the light mount is a plate fixed to the rear surface.

3. The moulding of claim 1, wherein the light source is positioned proximate to a plane of the front surface of the substrate.

4. The moulding of claim 1, wherein the moulding is a decorative moulding selected from the group consisting of crown moulding, baseboard, door casing, window casing, and ceiling medallions.

5. The moulding of claim 1, wherein the light source is a light emitting diode (LED).

6. The moulding of claim 5, wherein the light mount has a first tine receiving aperture and a second tine receiving aperture, and the LED is mounted to a driver board, the driver board has a first electrically conductive tine and a second electrically conductive tine, the first and the second tines are insertable into the first and the second tine receiving apertures to connect the driver board to the light mount.

7. The moulding of claim 6, wherein the driver board has a current intensity controller which controls the amount of current delivered to the LED to control the light intensity of the LED.

8. The moulding of claim 6, wherein the first tine is connected to the second tine by a diode bridge such that a flow of current to the LED in the driver board is always from the first tine to the second tine regardless of whether the first tine is inserted into the first aperture or the second aperture, with the second tine inserted into the other of the first aperture or second aperture.

9. The moulding of claim 5, wherein electricity supplied to the LED is either alternating current or direct current.

10. The moulding of claim 1, wherein the rear surface has a plurality of holes at a desired spacing with a corresponding plurality of light mounts positioned over the holes.

11. The moulding of claim 10, wherein each of the plurality of light mounts is electrically connected to adjacent light mounts by electrically conductive wires.

12. The moulding of claim 1, wherein the moulding is a modular unit and wires for connecting to a subsequent modular unit are provided at longitudinal ends of the substrate.

13. The moulding of claim 1, wherein a light cover is positioned at the front surface over the hole.

14. The moulding of claim 13, wherein the light cover is colorless.

15. The moulding of claim 13, wherein the light cover is coloured.

16. A method of making a modular moulding having embedded lighting, the method comprising the steps of:
obtaining a moulding having a front surface and a rear surface;
making a one hole in the moulding from the front surface to the rear surface;
fixing a light mount on the rear surface, the light mount having a light source positioned in the hole such that light from the light source can be seen from the front surface through the hole to provide direct lighting.

17. The method of claim 16, wherein a plurality of holes are made in the moulding, and a respective plurality of the light mounts are fixed on the rear surface, and connecting each of the plurality of light mounts to adjacent light mounts with electrically conductive wires.
